(19) United States
(12) Patent Application Publication
(10) Pub. No.: US 2026/0063599 A1
(43) Pub. Date: Mar. 5, 2026

(54) Method for Manufacturing a Valve for a Micro-Injector for a Liquid or Gas Chromatography Device

(71) Applicants: APIX ANALYTICS, GRENOBLE (FR); UNIVERSITE GUSTAVE EIFFEL, CHAMPS-SUR-MARNE (FR)

(72) Inventors: Eric COLINET, SAINT-ISMIER (FR); Kamel KHELLOUFI, SASSENAGE (FR); Pierre PUGET, SAINT-ISMIER (FR); Frédéric MARTY, MAGNY LE HONGRE (FR); Lionel ROUSSEAU, LE PERREUX SUR MARNE (FR)

(21) Appl. No.: 19/480,916

(22) PCT Filed: May 3, 2024
(86) PCT No.: PCT/EP2024/062343

§ 371 Date: Nov. 3, 2025

(30) Foreign Application Priority Data
May 3, 2023 (FR) FR2304453

(51) Int. Cl. G01N 30/20

(52) U.S. Cl. CPC G01N 30/20

(57) ABSTRACT

The invention relates to a method for manufacturing a valve for a micro-injector for a chromatography device, which comprises: o depositing a polymer layer (20) on a support substrate (10); o a first partial crosslinking treatment of the polymer layer (20); o etching the support substrate (10) to expose a free area (21) of the polymer layer (20); o assembling the support substrate (10) and a fluid distributor (300) via the polymer layer (20), such that:—the free area (21) forms a membrane having two opposite free surfaces (23, 24); and—a bonding area (25) of the polymer layer in rigid contact with the support substrate and with the distributor (300) forms an adhesive interface between the support substrate and the distributor; and o a second treatment comprising a continuation of the crosslinking of the polymer layer (20).

### FIELD OF THE INVENTION

This invention relates in general to the field of liquid or gas chromatography. More specifically, it proposes a method of manufacturing a valve for a micro-injector for a liquid or gas chromatography device.

### PRIOR ART

A measurement system for analysing a liquid or gas by liquid or gas chromatography comprises an injector, at least one separation column and at least one detector. It also includes elements providing the interface between said components.

Recently, compact analysis systems have been developed that can be transported or easily incorporated into existing analysis facilities. Micro-injectors have been developed to inject a defined volume of a fluid into the separation column of such a device. Such a fluid may be a gas or a liquid to be analysed.

Such a micro-injector typically consists of a set of valves of the two-state type, i.e. each valve can adopt a closed state which cuts off the flow of fluid through it, or an open state which allows the flow of fluid. An assembly of a plurality of valves are interconnected to form an injector. FIG. 1 illustrates an assembly of nine valves V1 to V9 linked by fluidic connections to form a ten-way micro-injector. Other numbers of ways and fluidic connection configurations are possible. The opening and closing of the valves is driven by a microprocessor.

In order to obtain a narrow injection peak for precise chromatography analysis, it is necessary to minimise the volumes of the fluidic interconnections between the valves, with the exception of the fluid trapping volume containing the sample to be analysed. Pneumatically or piezoelectrically actuated micro-valves are known to be used for this purpose. In the case of pneumatic actuation, one or more electronically controlled valves drive a pressurised fluid to deflect a flexible membrane which is often an elastic polymer such as polyimide.

This membrane is typically in the form of a film bonded between a glass substrate and a silicon substrate comprising the valve seat and fluidic connections. The membrane can be bonded using an adhesive film, a multi-layer film enabling sealing by thermocompression, an epoxy adhesive or a sintered glass or solder seal. Fixing the membrane by bonding with an adhesive film is described, for example, in U.S. Pat. No. 6,896,238 B2. A solder or sintered glass sealing is described in document U.S. Pat. No. 4,869,282 A.

However, such bonding requires the adhesive film to be precisely located between the glass and silicon substrates. This locating is achieved by using a mask, which makes valve assembly more complex.

In addition, such a bonding of the membrane requires the application of two adhesive layers and two alignment steps during valve assembly.

Since certain applications require valves to be kept in the closed state for long periods, the membrane is pushed onto the valve seat during these phases of use. However, the operating temperature of the micro-injector often induces adhesive properties in the membrane material, resulting in stiction of the membrane surface to the valve seat. When such stiction starts to occur, the valve will no longer operate correctly.

It is therefore necessary to prevent the valve seat from becoming connected to the membrane. U.S. Pat. No. 6,896,238 B2 proposes treating the membrane with one or more thin metal layers. However, such treatment makes the manufacture of the injector more complex, adding one or more deposition steps and the use of one or more additional masks.

A further post-treatment to avoid such stiction is described in “Micro-fabricated membrane gas valves with a non-stiction coating deposited by C₄F₈/Ar plasma” Shannon et al., J. Micromech. Microeng. 18 (2008) 095015 (9pp).

Improvements are also expected in terms of ease of assembly, manufacturing cost and the tightness of the injector sealing.

### DISCLOSURE OF THE INVENTION

One object of the invention is to design a manufacturing method for a micro-injector valve that is easy to implement and automate. In particular, one aim is to facilitate the alignment and sealing of fluid passages when assembling the valve and to enable precise actuation of the membrane during use of the micro-injector.

For this purpose, the invention proposes a method for manufacturing a valve for a micro-injector for a liquid or gas chromatography device, comprising the following steps:
liquid-phase deposition of a polymer layer on a lower surface of a support substrate,
a first partial crosslinking treatment of the polymer layer,
etching the support substrate to expose a free area of the polymer layer,
assembling the support substrate and a fluid distributor comprising a cavity comprising a seat configured to receive the membrane, and at least one micro-conduit in fluidic connection via the cavity in order to form a fluid passage,
said assembling being carried out by means of the polymer layer, such that
the free area of the polymer layer forms a membrane having two opposing free surfaces, such that, when an actuating force is applied to the membrane, the membrane comes into contact with the seat in order to seal off at least one micro-conduit,
a bonding area of the polymer layer is in integral contact with a bonding area of the lower face of the support substrate and with a bonding area of the upper face of the distributor, said bonding area of the polymer layer forming an adhesive sealing interface between the support substrate and the distributor,
a second treatment comprising a continuation of the crosslinking of the polymer layer enabling the first face of the bonding area to be sealed with the distributor.

The partial crosslinking of the polymer layer enables the adhesive properties of this layer to be used directly to bond the membrane in a sealed manner between a support substrate and a distributor comprising the valve seat and fluidic connections.

Polymers are used because of their elasticity and compatibility with photolithography structuring. In addition, polymers in liquid form prior to polymerisation can be easily deposited by centrifugation.

Particularly advantageously, the method further comprises a step of etching the support substrate and the polymer layer to produce at least one fluid passage before assembling of the support substrate and the fluid distributor, at least one micro-conduit of the distributor being suitable for communicating with said fluid passage, the assembling being carried out so that each fluid passage is aligned with a micro-conduit to form a respective fluid passage between the support substrate and the distributor.

According to a preferred embodiment, the polymer is a polyimide. A particular advantage of polyimides is their resistance to high temperatures and their inertness to a large number of chemicals.

The partial crosslinking step may comprise a first annealing at a temperature of between 80° C. and 150° C.

In certain embodiments, the partial crosslinking step comprises an ultraviolet irradiation step and/or a second annealing step.

In certain embodiments, the step of depositing the polymer layer comprises depositing an additional functional layer, such as a layer of metal, polycrystalline silicon, or a piezoelectric material, said additional functional layer being arranged on a face of the polymer layer or within the polymer layer.

According to a preferred embodiment, the support substrate is made of silicon.

The etching step may comprise plasma etching.

In certain embodiments, the step of crosslinking the polymer layer comprises a step of forming a vacuum and/or compressing the valve in a press and/or annealing.

The method may further comprise a step of aligning the fluid passage with a micro-conduit inlet arranged in the upper face of the fluid distributor.

Advantageously, the method also comprises a step of assembling the fluid distributor by soldering a glass substrate onto the lower face of a microfluidic circuit.

The invention also relates to a micro-injector valve for a liquid chromatography device or produced according to the method as described above, and comprising:
a support substrate with an upper face and a lower face,
a fluid distributor comprising a cavity comprising a seat and at least two micro-conduits in fluidic connection via the cavity to form a fluid passage, and
a polymer layer, advantageously made of polyimide, comprising:
   a bonding area in integral contact with a bonding area of the lower face of the support substrate and with a bonding area of the upper face of the distributor, such that the bonding area of the polymer layer forms an adhesive interface between the lower face of the support substrate and the upper face of the distributor, and
   a free area forming a membrane having two free faces facing the cavity, so that when an actuating force is applied to the membrane, the membrane comes into contact with the seat and closes at least one micro-conduit so as to interrupt the passage of fluid.

Particularly advantageously, the fluid distributor comprises a silicon substrate in which the cavity and the micro-conduits are formed, and a glass substrate forming the lower face of the distributor, said glass substrate being bonded to the lower face of the silicon substrate in a fluid-tight manner.

In certain embodiments, the valve further comprises:
at least one first fluid passage formed by at least two micro-conduits in fluidic connection via the cavity, said first fluid passage being suitable for establishing a fluidic connection between the fluid distributor and a device for supplying the fluid to be analysed, and
at least one second fluid passage suitable for establishing a fluidic connection between the membrane and a pneumatic device configured to actuate the membrane between a closed position in which the membrane seals the first fluid passage in a fluid-tight manner, and an open position in which the first fluid passage is open.

In certain embodiments, the first and second fluid passages are arranged in a first face of the valve.

The valve may further comprise a third fluid passage for establishing a fluidic connection between the fluid distributor and a chromatography column, said third opening being arranged in a second face of the valve opposite the first face.

Another object of the invention relates to a micro-injector for a liquid or gas chromatography device, comprising a plurality of interconnected valves as described above, at least one inlet for a carrier gas, at least one inlet for a fluid to be analysed, at least one fluid outlet for injecting a sample of the fluid to be analysed carried by the carrier gas into a chromatography column, a device for actuating the valves, and a microprocessor configured to control the actuation of the respective valves.

In certain embodiments the device for actuating the valves is a pneumatic device, the micro-injector further comprising at least one gas inlet configured to supply a valve actuation gas to said pneumatic device.

Finally, the invention relates to a liquid or gas chromatography device, comprising a liquid or gas chromatography column, a micro-injector as described above, configured to inject a fluid sample to be analysed into an inlet of the chromatography column, and a detector comprising an inlet suitable for being fluidically connected to an outlet of the chromatography column.

### BRIEF DESCRIPTION OF THE FIGURES

Other features and advantages of the invention will become apparent from the detailed description which follows with reference to the appended drawings in which:

FIG. 1 is a schematic top view of an assembly of valves and conduits in an injector.

FIG. 2A is a schematic cross-sectional view of a valve according to the invention.

FIG. 2B is a schematic view of a detail of the valve in FIG. 2A.

FIG. 3 is a schematic view of a silicon substrate intended to form the upper portion.

FIGS. 4A to 4D illustrate the steps for manufacturing the upper portion of the valve.

FIG. 5 is a schematic view of the upper portion of the valve.

FIGS. 6A and 6B illustrate the manufacturing stages of the distributor.

FIG. 7 is a perspective view of the distributor.

FIG. 8 is a schematic view of a gas distributor.

FIG. 9 is a schematic view of the valve before the assembly stage.

FIG. 10 is a perspective view of the valve after assembly.

### DETAILED DESCRIPTION OF THE EMBODIMENTS

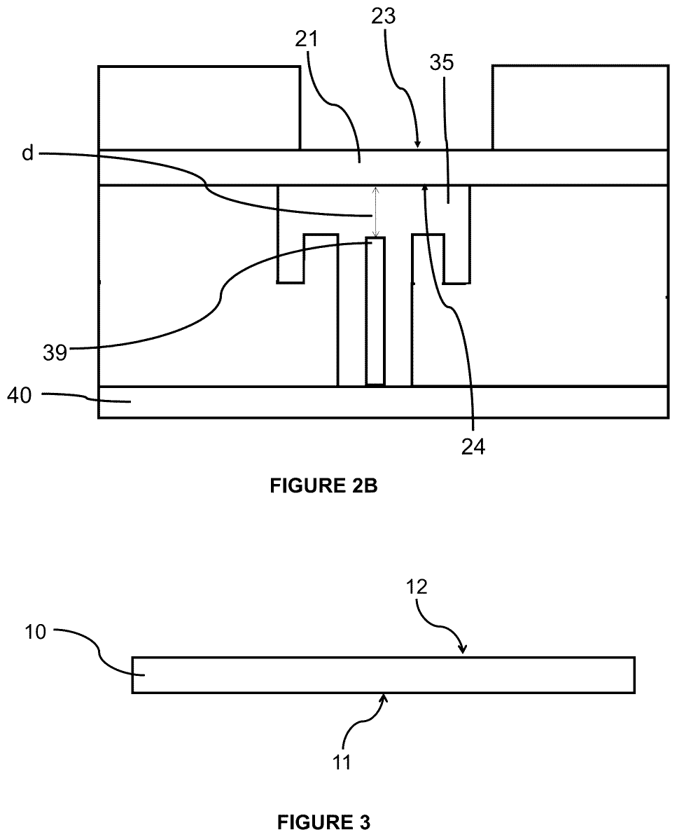

For the sake of clarity and simplification, a bottom-up orientation is used as shown in FIG. 2A, in which the valve is positioned so that the membrane is arranged above the fluid conduits that it is intended to close.

Thus, the terms “front”, “rear”, “up”, “upper”, “bottom” and “lower” will be used in the description without limiting the invention.

A valve according to the invention comprises an upper portion comprising a polymer layer forming a membrane, and a lower portion comprising a seat formed in a fluid distributor. Such a fluid may be a gas or a liquid to be analysed. During manufacture, the polymer layer is deposited in the liquid phase. This deposition technique enables the polymer layer to be deposited over the entire surface of the upper portion. Thus, a bonding area of the polymer layer forms an adhesive interface between the two upper and lower portions of the valve, and a free area of the polymer layer is intended to form the valve membrane. The polymer layer is crosslinked in two stages. The separation of these two crosslinking stages enables different areas of the membrane to be given different functions depending on their position within the valve.

FIG. 2A is a schematic view of a valve according to the invention. The valve is intended for use in a micro-injector for a liquid or gas chromatography device. The valve comprises an upper portion 100 comprising a polymer layer 20 forming the valve membrane, and a lower portion comprising a distributor 300 forming the valve seat. The upper portion 100 is rigidly attached to the distributor 300 via the polymer layer 20. Micro-conduits 51, 53A, 53B allow a fluid to pass inside the valve.

The term “micro-conduit” refers to a conduit with a cross-section less than or equal to 500 μm×500 μm, and the term “microfluidic passage” refers to a fluid passage formed by one or more micro-conduits.

The upper portion 100 comprises a support substrate 10 and the polymer layer 20. The support substrate 10 has a lower face 11 on which the polymer layer 20 is arranged, and an upper face 12 which corresponds to the outer face of the valve. In an illustrative and non-limiting manner, the support substrate has a thickness of between 0.2 mm and 2 mm. The support substrate 10 is made of a rigid material that is inert with respect to the fluids to be analysed, being typically made of glass or silicon. In certain embodiments, the support substrate can be a silicon-on-insulator (SOI) substrate, titanium, sapphire or a material compatible with microelectronic processes.

The polymer layer 20 is made of a flexible, elastic material that can withstand the temperatures used during chromatographic analysis and is inert with respect to the fluids to be analysed. The polymer is suitable for liquid phase deposition. Preferably, the polymer is photosensitive in order that it can be structured by photolithography. Typically, the polymer layer is made of a polyimide, preferably a photosensitive polyimide, in order to etch structures into this layer using a photolithography method. In certain cases, the polymer may be a photosensitive composition, such as an SU-8 type composition, or a benzocyclobutene (BCB) based polymer.

A bonding area 25 of the polymer layer 20 forms an adhesive interface between a bonding area 17 on the lower face 11 of the support substrate 10 and a bonding area 37 on the upper face of the distributor 300. The adhesive interface may be a single surface, or it may be composed of several distinct parts of the polymer layer 20.

A free area of the polymer layer forms a membrane 21 having two free faces 23, 24. An outer free face 23 is oriented facing the outside of the valve, and an inner free face 24 is oriented facing the distributor 300. Typically, on its outer face, the membrane 21 is completely surrounded by an area of the support substrate 10.

In certain embodiments, the polymer layer comprises an additional functional layer, for example a layer of metal, polycrystalline silicon or a piezoelectric material. Such an additional layer can be arranged on one of the faces of the polymer layer or within the polymer layer, which is accordingly composed of two superimposed polymer layers. Such additional layers can be used to add functionality to the valve membrane, for example to provide actuation of the membrane or to determine the actuation or efficiency of the valve.

The distributor 300 comprises a structured substrate 30 comprising a cavity 35 and micro-conduits 53A, 53B, and a substrate 40 forming the lower face of the distributor 300.

The structured substrate 30 is bonded to the substrate 40 forming the lower face of the distributor 300 in a fluid-tight manner. The substrate 40 forming the lower face of the distributor 300 is made of a rigid, inert, fluid-tight material, typically glass. The structured substrate 30 is typically made of silicon or another material that enables structures to be formed by an etching method.

With reference to FIG. 2B, the structured substrate 30 comprises a cavity 35 arranged on the upper face of the distributor 300 and facing the membrane 21. The structured substrate 30 further comprises a seat 39 arranged opposite the membrane 21. The seat 39 is configured to receive the membrane 21 when an actuating force is applied to membrane 21. In the absence of an actuating force, the distance d between the membrane 21 and the seat 39 allows the passage of a fluid. The distance d in the absence of an actuating force is typically between 10 μm and 50 μm.

With reference to FIG. 2A, the structured substrate 30 further comprises at least two micro-conduits 53A, 53B in fluid communication with the outside of the valve via the micro-conduits 51 arranged in the upper portion 100 of the valve. The micro-conduits 53A, 53B are in fluid communication with each other via the cavity 35. When an actuating force is applied to the membrane 21, the membrane 21 comes into contact with the seat 39 and closes at least one micro-conduit 53A, 53B. In this way, the flow of fluid between the micro-conduits 53A and 53B is interrupted.

In the embodiment shown in FIGS. 2A and 2B, the microfluidic passages are arranged on the outer face of the valve. In other embodiments, additional conduits can be arranged on the upper face, a side face and/or on the lower face of the valve. For example, a first passage formed by two micro-conduits can establish a fluidic connection between the fluid distributor and a device for supplying the fluid to be analysed. A second fluid passage may be present for establishing a fluidic connection between the membrane and a pneumatic device configured to actuate the membrane. Such a pneumatic device can apply an actuating force to the membrane to bring the membrane into a closed position in contact with the seat. In this closed position, the membrane tightly seals the first fluid passage. When the pneumatic device releases the actuating force, the membrane returns to an open position, thus opening the first fluid passage.

The valve may include a third fluid passage for establishing a fluidic connection between the fluid distributor and a chromatography column. In this case, it is advantageous to arrange the openings of the first and second fluid passages on an outer face of the valve, and the opening of the third fluid passage on an inner face opposite the outer face of the valve.

The manufacturing method for a valve according to the invention will now be described.

### Producing the Upper Portion of the Valve

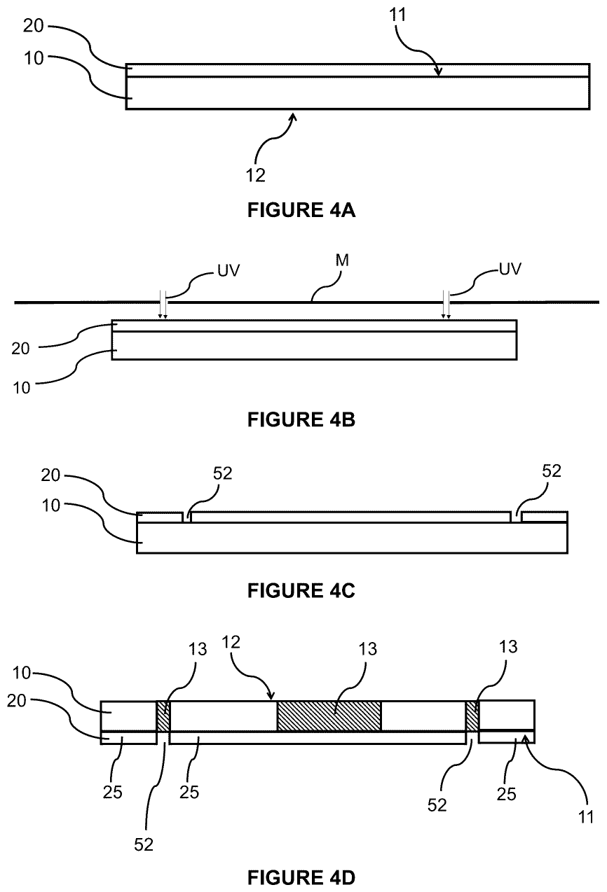

With reference to FIG. 3, a support substrate 10 is provided having: a lower face 11 intended to form the lower face bearing the membrane, and a face 12 intended to form the upper face which corresponds to an outer face of the valve opposite the lower face 11. With reference to FIG. 4A, a layer of polymer 20 is deposited in the liquid phase on the lower face 11 of the support substrate 10. During the deposition, the substrate is oriented upside down with respect to the orientation in which the valve is presented, i.e. the lower face 11 is oriented facing upwards to facilitate liquid phase deposition. Such a liquid phase deposition is typically carried out by centrifugation in order to obtain a thin layer suitable for forming an easily deformable membrane.

The deposited polymer layer 20 is then annealed. In an illustrative and non-limiting manner, this annealing can be carried out at a temperature of between 80° C. and 150° C. for a period of between 1 and 20 minutes. With reference to FIG. 4B, a first step is then carried out of structuring the partially crosslinked polymer layer by photolithography in order to form micro-conduits 51 passing through said polymer layer. This step comprises, in particular, using a mask M defining the position of the micro-conduits and the application of radiation, for example ultraviolet UV radiation, through said mask. The energy of the ultraviolet radiation is typically between 300 and 900 mJ/cm2.

The partial crosslinking of the deposited polymer layer 20 is continued by a heat treatment, typically at a temperature of between 30° C. and 150° C. for a period of between 10 and 60 minutes. After this step, the polymer layer 20 is sufficiently solidified and chemically stable to form a membrane. Simultaneously, the polymer layer remains sufficiently soft and tacky to allow the support substrate to be bonded to the distributor in a subsequent step.

If the polymer layer comprises other functional layers, the functional layers can be deposited after the polymer layer has been deposited. In certain (non-illustrated) cases, a second layer of polymer is deposited in order to complete the membrane.

With reference to FIG. 4C, a second photolithography structuring step, in particular photographic development, then enables the polymer layer 20 to be etched in the areas irradiated in the first structuring step illustrated in FIG. 4B. This type of development enables the polymer to be removed from the areas irradiated by ultraviolet radiation in order to produce openings designed to form micro-conduits 51 for the microfluidic passages of the valve.

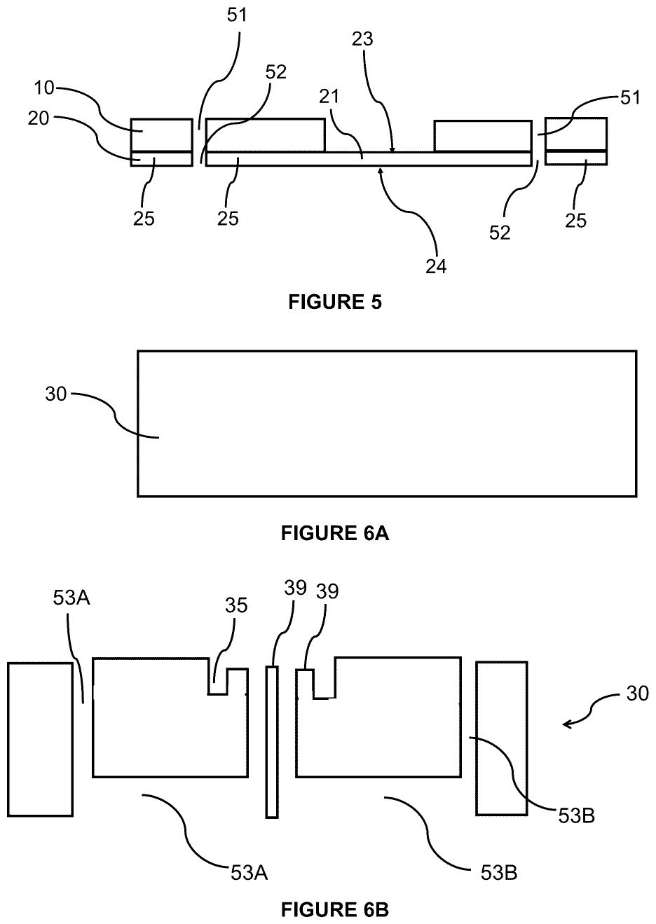

In the next step, with reference to FIG. 4D, a partial etching is performed to remove a first part 13 of the support substrate 10. With reference to FIG. 5, a free area 21 of the polymer layer 20 is thus exposed, such that said free area 21 has two free faces 23, 24. The etching can be performed by localised plasma machining. The free area is intended to form the membrane 21 of the valve. The bonding area 25 in which the polymer layer 20 is in contact with the support substrate 10 is intended to form an adhesive layer when the valve is assembled.

### Producing the Distributor

With reference to FIG. 6A, a distribution substrate 30 is used to form the distributor, which is intended to house the micro-conduits for the circulation of fluid within the valve. The distribution substrate 30 is typically made of silicon. The thickness of the distribution substrate 30 is typically between 0.2 and 2 mm. With reference to FIG. 6B, structuring is carried out by a plurality of photolithography and/or plasma etching steps. These steps produce the cavity 35 and the seat 39 of the valve, the fluid access and the microfluidic passages 53A, 53B. The cavity 35 and the seat 39 are typically produced by successive plasma etching steps on an upper face of the distribution substrate 30, said upper face being intended to face the membrane after assembly of the valve. Some microfluidic passages 53A, 53B pass through between the upper surface and a lower surface of the distribution substrate 30 and can be produced by etching from the upper face and/or the lower face of the substrate. Other microfluidic passages 53A, 53B pass through between the cavity and the lower face of the distribution substrate 30 and are produced by etching from the lower face of the substrate. Microfluidic passages 53A, 53B are also provided on the lower face of the distribution substrate 30, which may be fluidically connected to one or more through-passages.

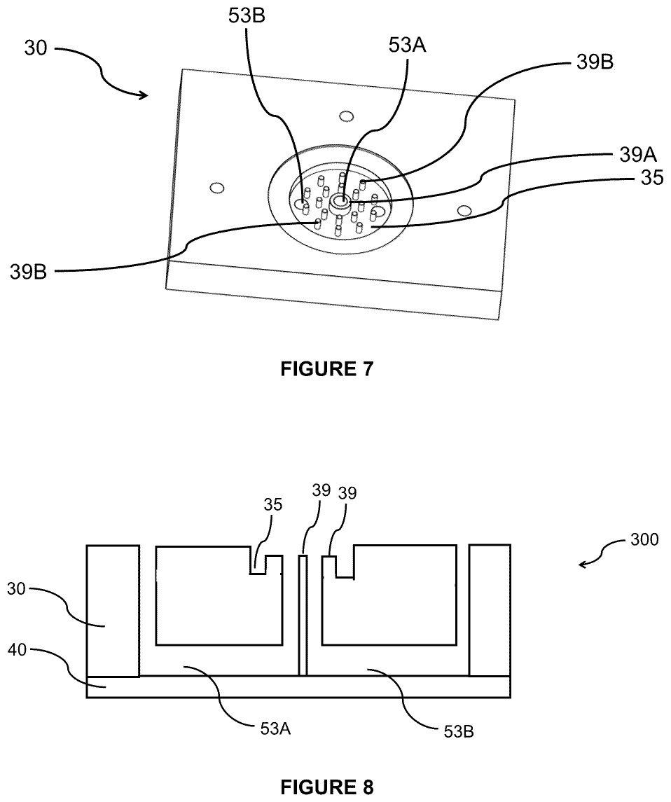

FIG. 7 illustrates the arrangement of cavity 35, seat 39 and micro-conduits 53A, 53B in perspective. The seat may comprise a central part 39A and/or several studs 39B distributed around the cavity 35. With reference to FIG. 8, the structured silicon substrate 30 is then soldered to a glass substrate 40 to form the lower face of the valve. For example, the substrate can be soldered to the glass substrate by anodic sealing. The glass substrate 40 typically has a thickness of between 0.2 and 2 mm. The fluidic passages 53A, 53B on the lower face of the distribution substrate 30 are thus closed, with the exception of any fluid inlets and/or outlets and the associated fluidic connections.

### Assembling the Valve

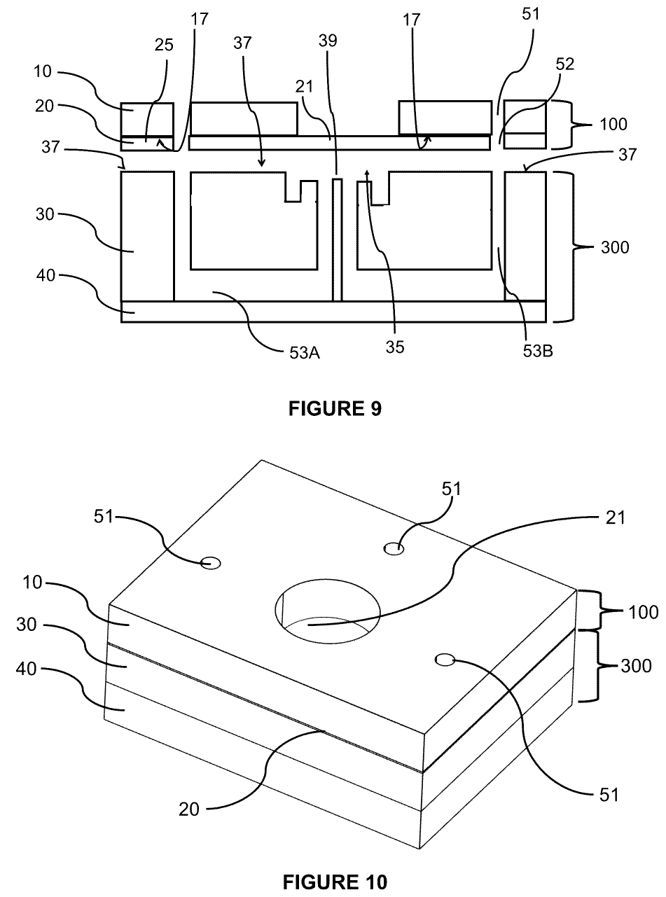

With reference to FIG. 9, the upper portion 100 and the distributor 300 are assembled such that the membrane 21 is positioned facing the seat 39 and the micro-conduits 51 of the upper portion 100 are aligned with the micro-conduits 53A, 53B of the distributor 300. Alignment can be carried out by manually using an optical device such as a microscope, or by a dedicated alignment machine.

The bonding area 25 of the polymer layer 20 is intended to form an adhesive interface between a bonding area 17 on the lower face 11 of the support substrate 10 and a bonding area 37 on the upper face of the distributor 300. During assembly, this bonding area 25 of the polymer layer is brought into contact with the bonding area 37 of the distributor, in order to achieve bonding with the upper portion 100. The upper portion 100 and the distributor 300 are then held in contact by applying a pressing force using a press. In an illustrative and non-limiting manner, the pressing force is between 2 N and 30 kN and the duration of compression is between 5 minutes and 5 hours.

Once the alignment and contact are complete, the crosslinking of the polymer layer 20 is continued in order to bond the upper portion 100 to the distributor 300. In an illustrative and non-limiting manner, continued crosslinking is carried out by thermocompression. During this step, the support substrate and the distributor can be aligned and placed in contact in a vacuum chamber in which the pressure is, for example, between 1×10⁻⁸ mbar and 1 bar. The assembled upper and lower portions are heated to a temperature of, for example, between 30° C. and 400° C.

After crosslinking, the associated portions are cooled to reach a temperature of between 20° C. and 80° C., for example. With reference to FIG. 10, the upper portion 100 and the distributor 300 are sealed and the valve is completed.

At this stage, the polymer layer has lost the adhesive properties that it presented in its partially crosslinked state. The crosslinked bonding area 25 forms a sealed connection between the respective surfaces of the support substrate and the distributor. The polymer layer enables the valve membrane to be produced simultaneously with the bonding of the upper portion to the distributor.

In certain embodiments, other substrates or materials can be deposited on the surface or on one or more interfaces of the valve during manufacture. For example, metals, polycrystalline silicon or piezoelectric materials can be deposited on the surface or between two successively deposited polymer layers.

### Using the Valve

After the valve has been assembled, an inlet of one microfluidic passage can be connected to a device for supplying the fluid to be analysed, and the outlet of the same microfluidic passage can be connected to an analysis device, in particular a liquid or gas chromatography column. Because the microfluidic passage comprises at least two conduits in fluidic connection via the cavity, the microfluidic passage can be opened or closed by actuating the membrane formed by the polymer layer.

A dedicated pneumatic device can be used to actuate the membrane in order to open and close the valve. In this case, in addition to the microfluidic conduits forming a passage through the cavity, the valve comprises at least one second fluid passage for establishing a fluidic connection between the membrane and the pneumatic device. This fluid passage comprises an inlet that is intended to be connected to the pneumatic device, and an outlet in fluid communication with the membrane.

The pneumatic device is used to apply a pneumatic pressure to the membrane. The membrane can then be pressed against the distributor seat in order to close the microfluidic passage. When the pneumatic pressure drops, the membrane returns to its original position and opens the microfluidic passage. Alternatively, a pressure can be applied on the membrane using another technique, such as a piezoelectric device.

When the membrane is pressed against the distributor seat, no stiction effect arises between the surface of the membrane and the valve seat due to the complete crosslinking of the membrane. It is not necessary to apply an additional anti-stiction treatment to the membrane or seat.

The arrangement of the microfluidic conduits can be designed according to the use of the valve and the design of the micro-injector in which the valve can be incorporated. For example, the inlet of one or more microfluidic passages passing through the cavity and the inlet of the fluid passage for connecting the pneumatic device can be arranged on an upper face of the valve. When such a valve is used for a micro-injector for chromatography analysis, an inlet to the microfluidic passage can be connected to a fluid supply device delivering the fluid to be analysed, and/or a device delivering a carrier gas. Thus, all the fluidic connections to the outside of the chromatography device are arranged on the same face of the valve. The valve may further comprises a third fluid passage for establishing a fluidic connection between the fluid distributor and a chromatography column. In this case, the valve can be designed so that the opening of said third fluid passage is arranged on a lower face of the valve, opposite the upper face. The lower face of the valve can thus comprise one or more fluidic connections to the inside of the chromatography device. In an illustrative and non-limiting manner, the upper face may be formed by the support substrate 10 and the outer free face 23 of the membrane, and the lower face may be the face formed by the glass substrate 40.

### Micro-Injector

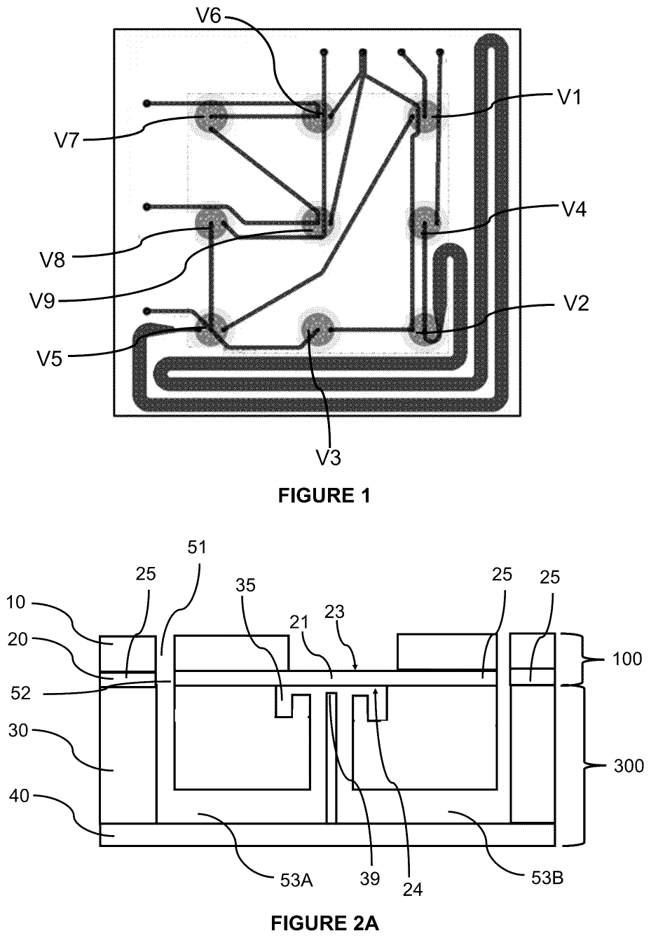

One or more valves according to the invention can be used to manufacture a micro-injector for chromatography analysis. For example, a plurality of valves can be assembled in an electronic circuit. The inputs and outputs are connected according to the application. For example, a first input is connected to a source of fluid to be analysed and a second input to a source of carrier gas. One or more outputs can be connected to one or more chromatography columns, for example to an analysis chromatography column and a respective output to a pre-column and/or reference column. One or more inputs and outputs can also be used to interconnect a plurality of respective valves, as illustrated in FIG. 1. Some valves can be used to manage flows during cleaning of the chromatography device. A control device can be connected to the chromatography device in order to drive a valve or a valve assembly using software. Such software drives the opening and closing parameters of each valve, such as the duration and/or force of actuation and/or the order of actuation of each respective valve in a valve assembly.

Such an assembly can be incorporated into a liquid or gas chromatography device comprising one or more chromatography columns and a detector.

### REFERENCES

U.S. Pat. No. 6,896,238 B2
U.S. Pat. No. 4,869,282 A
“Micro-fabricated membrane gas valves with a non-stiction coating deposited by C4F8/Ar plasma” Shannon et al., J. Micromech. Microeng. 18 (2008) 095015 (9pp)

1. A method for manufacturing a valve for a micro-injector for a liquid or gas chromatography device, said method comprising:
liquid-phase depositing a polymer layer on a lower surface of a support substrate,
partially crosslinking the polymer layer by applying a first treatment,
etching the support substrate to expose a free area of the polymer layer,
assembling the support substrate and a fluid distributor comprising a cavity comprising a seat configured to receive the membrane, and at least one micro-conduit in fluidic connection via the cavity in order to form a fluid passage,
said assembling including interposing the polymer layer between the support substrate and the fluid distributor such that
the free area of the polymer layer forms a membrane having two opposing free surfaces, such that, when an actuating force is applied to the membrane, the membrane comes into contact with the seat in order to seal off at least one micro-conduit, and
a bonding area of the polymer layer is in integral contact with a bonding area of the lower face of the support substrate and with a bonding area of the upper face of the distributor, said bonding area of the polymer layer forming an adhesive sealing interface between the support substrate and the distributor,
continuing crosslinking the polymer layer by applying a second treatment, the second treatment enabling the first face of the bonding area to be sealed with the distributor.

2. The method according to claim 1, further comprising etching the support substrate and the polymer layer to produce at least one fluid passage before assembling the support substrate and the fluid distributor, at least one micro-conduit of the distributor being suitable for communicating with a fluid passage,
the assembling being carried out such that each fluid passage is aligned with a micro-conduit to form a respective fluid passage between the support substrate and the distributor.

3. The method according to claim 1, wherein the polymer is a polyimide.

4. The method according to claim 3, wherein the first treatment comprises a first annealing at a temperature of between 80° C. and 150° C.

5. The method according to claim 1, wherein the first treatment comprises at least one of irradiating with ultraviolet radiation and carrying out a second annealing treatment.

6. The method according to claim 1, wherein depositing the polymer layer comprises depositing an additional functional layer, material said additional functional layer being arranged on a face of the polymer layer or within the polymer layer.

7. The method according to claim 1, wherein the support substrate is made of silicon.

8. The method according to claim 1, wherein the etching comprises plasma etching.

9. The method according to claim 1, wherein the second treatment comprises at least one of forming a vacuum, compressing the valve in a press, and annealing.

10. The method according to claim 9, further comprising aligning the fluid passage with a micro-conduit inlet arranged in the upper face of the fluid distributor.

11. The method according to claim 1, further comprising assembling the fluid distributor by soldering a glass substrate on the lower face of a microfluidic circuit.

12. A valve for a micro-injector for a liquid or gas chromatography device comprising:
a support substrate having an upper face and a lower face,
a fluid distributor comprising a cavity comprising a seat and at least two micro-conduits in fluidic connection via the cavity to form a fluid passage, and
a polymer layer, advantageously made of polyimide, comprising:
a bonding area in integral contact with a bonding area of the lower face of the support substrate and with a bonding area of the upper face of the distributor, such that the bonding area of the polymer layer forms an adhesive interface between the lower face of the support substrate and the upper face of the distributor, and
a free area forming a membrane having two free faces facing the cavity, so that when an actuating force is applied to the membrane, the membrane comes into contact with the seat and closes at least one micro-conduit so as to interrupt the passage of fluid.

13. The micro-injector valve according to claim 12, wherein the fluid distributor comprises a silicon substrate in which the cavity and the micro-conduits are formed, and a glass substrate forming the lower face of the distributor, said glass substrate being bonded to the lower face of the silicon substrate in a fluid-tight manner.

14. The valve according to claim 12, further comprising:
at least one first fluid passage formed by at least two micro-conduits in fluidic connection via the cavity, said first fluid passage being suitable for establishing a fluidic connection between the fluid distributor and a device for supplying the fluid to be analysed, and
at least one second fluid passage suitable for establishing a fluidic connection between the membrane and a pneumatic device configured to actuate the membrane between a closed position in which the membrane seals the first fluid passage in a fluid-tight manner, and an open position in which the first fluid passage is open.

15. The valve according to claim 14, wherein the first and second fluid passages are arranged in a first face of the valve.

16. The valve according to claim 15, further comprising a third fluid passage for establishing a fluidic connection between the fluid distributor and a chromatography column, said third opening being arranged in a second face of the valve opposite the first face.

17. A micro-injector for a liquid or gas chromatography device, comprising a plurality of interconnected valves according to claim 12, at least one inlet for a carrier gas, at least one inlet for a fluid to be analysed, at least one fluid outlet for injecting a sample of the fluid to be analysed carried by the carrier gas into a chromatography column, a device for actuating the valves, and a microprocessor configured to control the actuation of the respective valves.

18. The micro-injector according to claim 17, wherein the device for actuating the valves is a pneumatic device, the micro-injector further comprising at least one gas inlet configured to supply a valve actuation gas to said pneumatic device.

19. A liquid or gas chromatography device, comprising
a liquid or gas chromatography column,
a micro-injector according to claim 17, configured to inject a fluid sample to be analysed into an inlet of the chromatography column, and
a detector comprising an inlet suitable for being fluidically connected to an outlet of the chromatography column.

20. The method according to claim 6, wherein the additional functional layer is a layer of metal, polycrystalline silicon, or a piezoelectric material.
